(19) United States
(12) Patent Application Publication
(10) Pub. No.: US 2025/0304825 A1
(43) Pub. Date: Oct. 2, 2025

(54) POLISHING COMPOSITION

(71) Applicant: FUJIMI INCORPORATED, Kiyosu-shi (JP)

(72) Inventors: Yasunori OKADA, Kiyosu-shi (JP); Daiki ITO, Kiyosu-shi (JP)

(73) Assignee: FUJIMI INCORPORATED, Kiyosu-shi (JP)

(21) Appl. No.: 19/089,384

(22) Filed: Mar. 25, 2025

(30) Foreign Application Priority Data
Mar. 27, 2024 (JP) 2024-051514

(51) Int. Cl. C09G 1/02

(52) U.S. Cl. CPC C09G 1/02

(57) ABSTRACT

An object is to provide a polishing composition capable of reducing a polishing removal rate of polysilicon. An object is to provide a means capable of reducing a polishing removal rate of polysilicon and further reducing defects on a surface of polysilicon after polishing. A polishing composition contains abrasive grains and a polishing removal rate inhibitor that reduces a polishing removal rate of polysilicon, and the polishing removal rate inhibitor is a water-soluble polymer meeting all requirements below: 1) a number average molecular weight is 200 or more and 600 or less; 2) a compound having a repeating unit formed of AO in which A is an alkylene group and O is an oxygen atom is contained; and 3) a compound having a special repeating unit in which two oxygen atoms are further added to the repeating unit is contained in an amount of more than 0 mass % and less than 0.1 mass % with respect to the entire water-soluble polymer.

### CROSS-REFERENCE TO RELATED APPLICATION

The present application is based on Japanese Patent Application No. 2024-051514 filed on Mar. 27, 2024, the disclosure content of which is incorporated herein by reference in its entirety.

### BACKGROUND

### 1. Technical Field

The present invention relates to a polishing composition.

### 2. Description of Related Arts

In the current semiconductor industry, the development of semiconductor manufacturing process technology is continuously advanced. In recent years, with the increasingly stringent requirement on the surface quality of wafers, higher levels of smoothness and flatness are required also in polishing of wafers.

It has already been known that the surface quality of wafers can be improved by chemical mechanical polishing (hereinafter referred to as “CMP”). CMP utilizes chemical and mechanical interaction to achieve flatness of the surface to be polished. The chemical action is provided by a composition also referred to as a CMP slurry. The mechanical action is usually allowed to proceed with a polishing pad mounted on a table and pressed toward the surface to be polished.

Examples of the CMP include application to a gate forming step in transistor fabrication. When a transistor is fabricated, Si-containing materials such as silicon, polycrystalline silicon (polysilicon), silicon oxide, and silicon nitride may be polished, and it is required to control the polishing removal rate of each Si-containing material depending on the structure of the transistor.

For example, JP 2013-251561 A provides a polishing composition that can be suitably used for polishing a silicon material such as silicon simple substance or a silicon compound, and a polishing method using the same.

### SUMMARY

Under the circumstance that it is required to control the polishing removal rate of each Si-containing material as described above, the present inventors have found that it would be required to reduce the polishing removal rate of polysilicon.

However, it is known that polysilicon and silicon oxide (silicon dioxide) are soft and generally easily react with a polishing agent, and it is difficult to reduce the polishing removal rate of polysilicon.

Therefore, an object of the present invention is to provide a polishing composition capable of reducing a polishing removal rate of polysilicon.

In addition, the present inventors have found that there are defects or the like on the surface of polysilicon after polishing in the course of studying to achieve the above object.

Therefore, another object of the present invention is to provide a means capable of further reducing defects on the surface of polysilicon after polishing.

The present inventors conducted intensive studies in order to achieve at least one of the above objects. As a result, the present inventors found that it is possible to achieve the object by a polishing composition containing abrasive grains and a polishing removal rate inhibitor that reduces a polishing removal rate of polysilicon, in which the polishing removal rate inhibitor is a water-soluble polymer meeting all requirements below: 1) a number average molecular weight is 200 or more and 600 or less; 2) a compound having a repeating unit formed of AO in which A is an alkylene group and O is an oxygen atom is contained; and 3) a compound having a special repeating unit in which two oxygen atoms are further added to the repeating unit is contained in an amount of more than 0 mass % and less than 0.1 mass % with respect to the entire water-soluble polymer, and thus completed the present invention.

According to the present invention, it is possible to provide a polishing composition capable of reducing the polishing removal rate of polysilicon. In addition, it is possible to provide a means capable of further reducing defects on the surface of polysilicon after polishing.

### DETAILED DESCRIPTION

In the present specification, “X to Y” is used to mean that numerical values (X and Y) described before and after that are included as a lower limit value and an upper limit value, and means “X or more and Y or less”. In a case where a plurality of “X to Y” are described, for example, in a case where “X1 to Y1, or X2 to Y2” is described, a disclosure in which each numerical value is an upper limit, a disclosure in which each numerical value is a lower limit, and a combination of the upper limit and the lower limit are all disclosed (that is, it is a legal basis for amendment). Specifically, all of an amendment to X1 or more, an amendment to Y2 or less, an amendment to X1 or less, an amendment to Y2 or more, an amendment to X1 to X2, an amendment to X1 to Y2, and the like should be regarded as legitimate. In addition, unless otherwise specified, operations and measurements of physical properties and the like are performed under the conditions of room temperature (20 to 25° C.)/relative humidity of 40 to 50% RH. The concentration described in the present specification may be a concentration at POU (point of use) or a concentration before dilution to the concentration at POU. It should also be understood that all embodiments and combinations of descriptions disclosed herein are disclosed in this application. That is, it should be understood that it can be a basis for amendment. In addition, when the content or concentration of each component is described, it can be the total amount when two or more types thereof are contained.

According to one aspect of the present invention, a polishing composition contains abrasive grains and a polishing removal rate inhibitor that reduces a polishing removal rate of polysilicon, and the polishing removal rate inhibitor is a water-soluble polymer meeting all requirements below: 1) a number average molecular weight is 200 or more and 600 or less; 2) a compound having a repeating unit formed of AO in which A is an alkylene group and O is an oxygen atom is contained; and 3) a compound having a special repeating unit in which two oxygen atoms are further added to the repeating unit is contained in an amount of more than 0 mass % and less than 0.1 mass % with respect to the entire water-soluble polymer. With such a configuration, it is possible to provide a polishing composition capable of reducing the polishing removal rate of polysilicon. In addition, it is possible to provide a means capable of further reducing defects on the surface of polysilicon after polishing.

In the present specification, the residue represents a foreign substance adhering to the surface of a polished object to be polished. Examples of the residue include an organic residue, a particle residue derived from abrasive grains contained in the polishing composition, and other residues other than the particle residue and the organic residue.

In the present specification, the organic residue represents a component made of an organic substance such as an organic low molecular weight compound or an organic polymer compound, an organic salt, or the like, among foreign substances adhering to the surface of a polished object to be polished. Examples of the organic residue adhering to the polished object to be polished include pad debris generated from a pad used in a polishing step described later, and a component derived from an additive contained in the polishing composition used in the polishing step. Since the organic residue and other residues are greatly different in color and shape, whether or not a residue is an organic residue can be visually determined by, for example, scanning electron microscope (SEM) observation. In addition, whether or not a residue is an organic residue may be determined by an elemental analysis using an energy dispersive X-ray analyzer (EDX) attached to an SEM as necessary.

In the present specification, the term “water-soluble” means that the solubility in water (25° C.) is 1 g/100 mL or more, and the term “polymer” refers to a (co)polymer having at least one of a weight average molecular weight (Mw) and a number average molecular weight (Mn) of 200 or more.

### [Abrasive Grains]

The polishing composition according to the present invention contains abrasive grains. The abrasive grains have an action of mechanically polishing an object to be polished, and improve the polishing removal rate of the object to be polished with the polishing composition.

Examples of the type of abrasive grains used in the polishing composition according to the present invention include metal oxides such as silica, alumina, zirconia, and titania. As the abrasive grains, one type may be used alone or two or more types may be used in combination. As the abrasive grains, a commercially available product may be used, or a synthetic product may be used.

The type of abrasive grain is preferably silica, and more preferably colloidal silica. Examples of a method for producing colloidal silica include a sodium silicate method and a sol-gel method, and colloidal silica produced by any production method is suitably used as the colloidal silica according to the present invention. However, from the viewpoint of reducing metal impurities, colloidal silica produced by a sol-gel method is preferable. Colloidal silica produced by a sol-gel method is preferable because the content of metal impurities having a property of diffusing in a semiconductor or corrosive ions such as chloride ions is small. The production of colloidal silica by a sol-gel method can be performed using a conventionally known method, and specifically, colloidal silica can be obtained by performing a hydrolysis/condensation reaction using a hydrolyzable silicon compound (for example, an alkoxysilane or a derivative thereof) as a raw material. As the colloidal silica, a commercially available product may be used. According to an embodiment of the present invention, 85 mass % or more, 90 mass % or more, 95 mass % or more, 98 mass % or more, or 99 mass % or more of the particles constituting the abrasive grains is made of silica (particularly colloidal silica) (the upper limit is 100 mass %).

The shape of the colloidal silica is not particularly limited, and may be a spherical shape or a non-spherical shape. Specific examples of the non-spherical shape include various shapes such as a polygonal columnar shape such as a triangular prism or a quadrangular prism, a cylindrical shape, a straw rice bag shape in which a central portion of a cylinder is bulged more than the end portions, a doughnut shape in which a central portion of a disk is perforated, a plate shape, a so-called cocoon shape having a constriction at a central portion, a so-called associative spherical shape in which a plurality of particles are integrated, a so-called kompeito shape having a plurality of protrusions on a surface, and a rugby ball shape, and are not particularly limited.

In the polishing composition of the present invention, the colloidal silica may have a cationic group on the surface. That is, the colloidal silica may be cationically modified colloidal silica (cationically modified colloidal silica). Preferred examples of the cationically modified colloidal silica include colloidal silica in which an amino group is immobilized on the surface. Examples of a method for producing such colloidal silica having a cationic group include a method for immobilizing a silane coupling agent having an amino group such as aminoethyltrimethoxysilane, aminopropyltrimethoxysilane, aminoethyltriethoxysilane, aminopropyltriethoxysilane, aminopropyldimethylethoxysilane, aminopropylmethyldiethoxysilane, or aminobutyltriethoxysilane on the surface of silica particles as described in JP 2005-162533 A. Thereby, colloidal silica (amino group-modified colloidal silica) in which an amino group is immobilized on the surface can be obtained.

In the polishing composition of the present invention, the colloidal silica may have an anionic group on the surface. That is, the colloidal silica may be anion-modified colloidal silica (anionically modified colloidal silica). Preferred examples of the anion-modified colloidal silica include colloidal silica in which an anionic group such as a carboxylic acid group, a sulfonic acid group, a phosphonic acid group, or an aluminic acid group is immobilized on the surface. A method for producing such colloidal silica having an anionic group is not particularly limited, and examples thereof include a method for allowing a silane coupling agent having an anionic group at a terminal to react with colloidal silica.

In a specific example, when a sulfonic acid group is immobilized on colloidal silica, the immobilization can be performed by, for example, the method described in “Sulfonic acid-functionalized silica through quantitative oxidation of thiol groups”, Chem. Commun. 246-247 (2003). Specifically, colloidal silica in which a sulfonic acid group is immobilized on the surface (sulfonic acid-immobilized colloidal silica, sulfonic acid-modified colloidal silica) can be obtained by allowing a silane coupling agent having a thiol group such as 3-mercaptopropyltrimethoxysilane to react with colloidal silica, and then oxidizing the thiol group with hydrogen peroxide.

When a carboxylic acid group is immobilized on colloidal silica, the immobilization can be performed by, for example, the method described in “Novel Silane Coupling Agents Containing a Photolabile 2-Nitrobenzyl Ester for Introduction of a Carboxy Group on the Surface of Silica Gel”, Chemistry Letters, 3, 228-229 (2000). Specifically, colloidal silica in which a carboxylic acid group is immobilized on the surface (carboxylic acid-immobilized colloidal silica, carboxylic acid-modified colloidal silica) can be obtained by coupling a silane coupling agent containing a photoreactive 2-nitrobenzyl ester to colloidal silica, followed by irradiation with light.

Among them, from the viewpoint of further reducing the polishing removal rate of polysilicon and further reducing defects on the surface of polished polysilicon, the abrasive grains are preferably anion-modified colloidal silica, and more preferably colloidal silica in which a sulfonic acid group is immobilized on the surface (sulfonic acid-immobilized colloidal silica, sulfonic acid-modified colloidal silica).

The size of the abrasive grains according to the present invention is not particularly limited. For example, the average primary particle size of the abrasive grains is preferably 5 nm or more, more preferably 10 nm or more, still more preferably 15 nm or more, and particularly preferably 20 nm or more. As the average primary particle size of the colloidal silica increases, the polishing removal rate of the object to be polished with the polishing composition is improved. The average primary particle size of the abrasive grains is preferably 200 nm or less, more preferably 150 nm or less, still more preferably 100 nm or less, and particularly preferably 50 nm or less. As the average primary particle size of the abrasive grains decreases, it becomes easier to obtain a surface with fewer defects by polishing using the polishing composition. That is, the average primary particle size of the abrasive grains is preferably 5 nm or more and 200 nm or less, more preferably 10 nm or more and 150 nm or less, still more preferably 15 nm or more and 100 nm or less, and particularly preferably 20 nm or more and 50 nm or less. The average primary particle size of the abrasive grains can be calculated, for example, based on the specific surface area (SA) of the abrasive grains calculated from the BET method on the assumption that the shape of the abrasive grains is a true sphere. For example, the average primary particle size of the abrasive grains can be calculated from the specific surface area of the abrasive grains measured by the BET method using “Flow Sorb II 2300” manufactured by Micromeritics Instruments Corporation and the true density of the abrasive grains.

The average secondary particle size of the abrasive grains is not particularly limited, but is preferably 10 nm or more, more preferably 15 nm or more, still more preferably 20 nm or more, and particularly preferably 25 nm or more. As the average secondary particle size of the abrasive grains increases, the resistance during polishing decreases, and stable polishing can be performed. The average secondary particle size of the abrasive grains is preferably 400 nm or less, more preferably 300 nm or less, still more preferably 200 nm or less, and particularly preferably 100 nm or less. As the average secondary particle size of the abrasive grains decreases, the surface area per unit mass of the abrasive grains increases, the contact frequency with the object to be polished is improved, and the polishing removal rate is further improved. That is, the average secondary particle size of the abrasive grains is preferably 10 nm or more and 400 nm or less, more preferably 15 nm or more and 300 nm or less, still more preferably 20 nm or more and 200 nm or less, and particularly preferably 25 nm or more and 100 nm or less. The average secondary particle size of the abrasive grains can be measured by, for example, a dynamic light scattering method represented by a laser diffraction scattering method.

The average degree of association of the abrasive grains is preferably 5.0 or less, more preferably 4.0 or less, and still more preferably 3.0 or less. As the average degree of association of the abrasive grains decreases, defects can be further reduced. The average degree of association of the abrasive grains is also preferably 1.0 or more, more preferably 1.5 or more, and still more preferably 2.0 or more. As the average degree of association of the abrasive grains increases, there is an advantageous effect that the polishing removal rate of the object to be polished with the polishing composition is improved. That is, the average degree of association of the abrasive grains is preferably 1.0 or more and 5.0 or less, more preferably 1.5 or more and 4.0 or less, and still more preferably 2.0 or more and 3.0 or less. This average degree of association is obtained by dividing the value of the average secondary particle size of the abrasive grains by the value of the average primary particle size.

The upper limit of the aspect ratio of the abrasive grains in the polishing composition is not particularly limited, but is preferably less than 2.0, more preferably 1.8 or less, and still more preferably 1.5 or less. When the upper limit is in such a range, defects on the surface of the object to be polished can be further reduced. The aspect ratio is an average of values obtained by taking the smallest rectangle circumscribing the image of an abrasive grain particle with a scanning electron microscope and dividing the length of the long side of the rectangle by the length of the short side of the same rectangle, and can be obtained using general image analysis software. The lower limit of the aspect ratio of the abrasive grains in the polishing composition is not particularly limited, but is preferably 1.0 or more.

The size (such as average primary particle size, average secondary particle size, or average degree of association) of the abrasive grains can be appropriately controlled by, for example, selecting the method for producing the abrasive grains.

The concentration (content) of the abrasive grains in the polishing composition is not particularly limited. In the case of a polishing composition used for polishing the object to be polished as a polishing liquid as it is (which is typically a polishing liquid in a slurry form, and may be referred to as a working slurry or a polishing slurry), the lower limit of the concentration (content) of the abrasive grains in the polishing composition is preferably 0.1 mass % or more, more preferably 0.5 mass % or more, still more preferably 0.6 mass % or more, even more preferably 0.8 mass % or more, and particularly preferably 1 mass % or more with respect to the total mass of the polishing composition. The upper limit of the concentration (content) of the abrasive grains in the polishing composition is preferably 15 mass % or less, more preferably 10 mass % or less, still more preferably 8 mass % or less, even more preferably 6 mass % or less, and particularly preferably 5 mass % or less with respect to the total mass of the polishing composition.

That is, in the case of a polishing composition used for polishing the object to be polished as a polishing liquid as it is, the concentration (content) of the abrasive grains is preferably 0.1 mass % or more and 15 mass % or less, more preferably 0.5 mass % or more and 10 mass % or less, still more preferably 0.6 mass % or more and 8 mass % or less, even more preferably 0.8 mass % or more and 6 mass % or less, and particularly preferably 1 mass % or more and 5 mass % or less with respect to the total mass of the polishing composition.

In the case of a polishing composition (that is, a concentrated liquid or a stock solution of a working slurry) used for polishing after dilution, the concentration (content) of the abrasive grains is usually appropriately 30 mass % or less, and more preferably 25 mass % or less from the viewpoint of storage stability, filterability, and the like. In addition, from the viewpoint of taking advantage of the concentrated liquid, the concentration (content) of the abrasive grains is preferably more than 1 mass %, and more preferably 2 mass % or more.

When the polishing composition contains two or more types of abrasive grains, the concentration (content) of the abrasive grains means the total thereof.

### [Polishing Removal Rate Inhibitor]

The polishing removal rate inhibitor contained in the polishing composition of the present invention is a water-soluble polymer having all the following requirements: 1) a number average molecular weight is 200 or more and 600 or less; 2) a compound having a repeating unit formed of AO in which A is an alkylene group and O is an oxygen atom is contained; and 3) a compound having a special repeating unit in which two oxygen atoms are further added to the repeating unit is contained in an amount of more than 0 mass % and less than 0.1 mass % with respect to the entire water-soluble polymer.

1) The water-soluble polymer as the polishing removal rate inhibitor contained in the polishing composition of the present invention has a number average molecular weight of 200 or more and 600 or less. When the number average molecular weight is less than 200, the ability to reduce the polishing removal rate of polysilicon is weak, and the polishing removal rate cannot be adjusted to a given polishing removal rate of polysilicon. When the number average molecular weight exceeds 600, the water-soluble polymer is easily adsorbed on polysilicon, and an organic residue is attracted by hydrophobic interaction to increase the number of defects. The number average molecular weight is preferably 250 or more, preferably 300 or more, and more preferably 350 or more. The number average molecular weight of the water-soluble polymer is preferably 580 or less, more preferably 560 or less, and still more preferably 540 or less. That is, the number average molecular weight of the water-soluble polymer as the polishing removal rate inhibitor is preferably 250 or more and 580 or less, preferably 300 or more and 560 or less, and more preferably 350 or more and 540 or less. The number average molecular weight of the water-soluble polymer as the polishing removal rate inhibitor can be measured by gel permeation chromatography (GPC), and the details of the measurement method are described in examples.

2) The water-soluble polymer as the polishing removal rate inhibitor contained in the polishing composition of the present invention include a compound which has a repeating unit formed of AO, in which A is an alkylene group, and O is an oxygen atom. From another viewpoint, the water-soluble polymer as the polishing removal rate inhibitor contained in the polishing composition of the present invention has a polyoxyalkylene chain. According to an embodiment of the present invention, the number of carbon atoms in the alkylene group represented by A is preferably 1 to 10, more preferably 2 to 5, still more preferably 2 to 4, and particularly preferably 3. When the number of carbon atoms is in such a range, the objective effect of the present invention can be achieved while maintaining the storage stability of the polishing composition.

Examples of the water-soluble polymer having a polyoxyalkylene chain (having a repeating unit formed of AO in which A is an alkylene group and O is an oxygen atom) include polyethylene glycol (PEG), polypropylene glycol (PPG), polytetramethylene glycol, polytetramethylene ether glycol, polypentylene glycol, polyhexylene glycol, polyheptylene glycol, polyoctylene glycol, polynonylene glycol, and polydecylene glycol; a block copolymer or a random copolymer of at least two types selected from polyethylene glycol, polypropylene glycol, and polytetramethylene glycol; a random copolymer or a block copolymer of ethylene oxide and propylene oxide or ethylene oxide and butylene oxide; polyglycerin, and a polyethylene oxide-polyvinyl alcohol graft copolymer. Among them, the polishing removal rate inhibitor is preferably at least one type selected from the group consisting of polyethylene glycol, polypropylene glycol, polytetramethylene glycol, and polyglycerin, more preferably at least one type selected from the group consisting of polyethylene glycol, polypropylene glycol, and polytetramethylene glycol, and particularly preferably polypropylene glycol. According to an embodiment of the present invention, the polishing removal rate inhibitor contains polypropylene glycol. According to an embodiment of the present invention, 80 mass % or more, 85 mass % or more, 90 mass % or more, 95 mass % or more, or 99 mass % or more (the upper limit is 100 mass %) of the water-soluble polymer having a repeating unit formed of AO is made up of polypropylene glycol.

3) The water-soluble polymer as the polishing removal rate inhibitor contained in the polishing composition of the present invention contains a compound (in the present specification also referred to as a structurally defective compound) having a special repeating unit in which two oxygen atoms are further added to a repeating unit formed of AO (that is, the repeating unit of the structurally defective compound is not formed of AO but formed of AO+O₂), and the content of the structurally defective compound is more than 0 mass % and less than 0.1 mass % with respect to the entire water-soluble polymer. The details of the above 3) will be described using polypropylene glycol as an example. Polypropylene glycol can be easily prepared because a synthetic method thereof has also been established and a commercially available product thereof is also available. However, the present inventors found that such a general polypropylene glycol contains a trace amount of a compound (structurally defective compound (also referred to as PPG+O₂)) having a repeating unit in which two oxygen atoms are bonded to a repeating unit of polypropylene glycol, which is different from the original structure of polypropylene glycol, by an analysis using a liquid chromatography mass spectrometer (LC/MS). It was found that when an object to be polished containing polysilicon is polished with the polishing composition containing polypropylene glycol containing such a structurally defective compound (that is, a mixture containing polypropylene glycol and the structurally defective compound), defects (an increase in organic residues) occur in the polished polysilicon (Comparative Example 6). Therefore, in order to reduce defects (an increase in organic residues), the present inventors tried to polish the object to be polished containing polysilicon with the polishing composition containing the one from which the structurally defective compound has been completely removed (that is, polypropylene glycol itself). However, it was found that another defect (mainly, an increase in particle residues (abrasive grain residues)) occurred in the polished polysilicon (Comparative Example 1). Therefore, the present inventors prepared polypropylene glycol containing the structurally defective compound in an extremely small amount, and polished the object to be polished containing polysilicon with the polishing composition containing the polypropylene glycol, and surprisingly found that the amount of defects in polysilicon can be reduced, and thus completed the present invention (Examples). As described above, the polishing removal rate inhibitor of the present invention is a mixture formed of a water-soluble polymer having a polyoxyalkylene chain (in particular polypropylene glycol) and a structurally defective compound (a compound having a repeating unit in which two oxygen atoms are bonded to a repeating unit of polypropylene glycol) at a specific concentration.

The amount of the structurally defective compound contained in the polishing removal rate inhibitor of the present invention (for example, a mixture formed of polypropylene glycol and a structurally defective compound at a specific concentration) can be controlled, for example, by performing an adsorption treatment with a synthetic adsorbent. A method of the adsorption treatment with a synthetic adsorbent can reduce impurities, for example, by preparing a mixture containing a water-soluble polymer having a polyoxyalkylene chain (particularly, a mixture formed of polypropylene glycol and a structurally defective compound) as an aqueous solution so as to have a given concentration (for example, 5 to 19 mass %, 6 to 18 mass %, 7 to 17 mass %, 8 to 16 mass %, 9 to 15 mass %, 10 to 14 mass %, or 11 to 13 mass %), then mixing and stirring a synthetic adsorbent in the aqueous solution to adsorb impurities to the synthetic adsorbent. The addition amount of the synthetic adsorbent may be appropriately adjusted so that the content of the structurally defective compound becomes a predetermined concentration. After the treatment with the synthetic adsorbent is performed, the used synthetic adsorbent can be removed from the aqueous solution of the water-soluble polymer using a filter.

According to an embodiment of the present invention, the polishing removal rate inhibitor of the present invention can be prepared by performing a treatment such that the concentration of the structurally defective compound is more than 0 mass % and less than 0.1 mass % in a mixture formed of a water-soluble polymer having a polyoxyalkylene chain (particularly, polypropylene glycol) and the structurally defective compound.

According to an embodiment of the present invention, two or more types of water-soluble polymers having a polyoxyalkylene chain having different contents of a structurally defective compound are prepared and mixed by appropriately selecting the mixing mass ratio thereof, whereby the polishing removal rate inhibitor of the present invention in which the concentration of the structurally defective compound is more than 0 mass % and less than 0.1 mass % can be prepared. For example, the polishing removal rate inhibitor of the present invention can be prepared by mixing a water-soluble polymer having a polyoxyalkylene chain not containing a structurally defective compound and a water-soluble polymer having a polyoxyalkylene chain containing a structurally defective compound at an appropriately selected mixing mass ratio.

As the polishing removal rate inhibitor of the present invention, one type may be used alone or two or more types may be used in combination.

According to an embodiment of the present invention, the content (concentration) of the structurally defective compound in the mixture containing the water-soluble polymer having a polyoxyalkylene chain is 0.0001 mass % or more, 0.0003 mass % or more, 0.0005 mass % or more, 0.0007 mass % or more, 0.0009 mass % or more, 0.001 mass % or more, 0.0011 mass % or more, 0.0013 mass % or more, 0.0015 mass % or more, 0.0017 mass % or more, 0.0019 mass % or more, 0.0021 mass % or more, 0.0023 mass % or more, 0.0025 mass % or more, 0.0027 mass % or more, 0.0029 mass % or more, 0.0031 mass % or more, 0.0033 mass % or more, 0.0035 mass % or more, 0.0037 mass % or more, 0.0039 mass % or more, 0.0041 mass % or more, 0.005 mass % or more, 0.007 mass % or more, 0.01 mass % or more, 0.02 mass % or more, 0.03 mass % or more, or 0.035 mass % or more.

According to an embodiment of the present invention, the content (concentration) of the structurally defective compound in the mixture containing the water-soluble polymer having a polyoxyalkylene chain is 0.09 mass % or less, 0.08 mass % or less, 0.07 mass % or less, 0.06 mass % or less, 0.05 mass % or less, 0.04 mass % or less, 0.03 mass % or less, 0.035 mass % or less, 0.02 mass % or less, 0.01 mass % or less, 0.009 mass % or less, 0.007 mass % or less, 0.005 mass % or less, or 0.003 mass % or less.

The lower limit of the concentration (content) of the polishing removal rate inhibitor in the polishing composition is not particularly limited, but is 0.05 mass % or more, 0.1 mass % or more, 0.15 mass % or more, 0.2 mass % or more, 0.25 mass % or more, 0.3 mass % or more, 0.35 mass % or more, 0.4 mass % or more, 0.45 mass % or more, 0.5 mass % or more, or 0.55 mass % or more. The upper limit of the concentration (content) of the polishing removal rate inhibitor in the polishing composition is 10 mass % or less, 5 mass % or less, 4 mass % or less, 3 mass % or less, 2 mass % or less, 1 mass % or less, 0.9 mass % or less, 0.8 mass % or less, or 0.7 mass % or less. In the case of combining two or more types, the concentration may be set so that the total thereof is the above concentration.

### [Defect Reducing Agent]

The polishing composition according to the present invention preferably contains a defect reducing agent that reduces defects on the surface of polysilicon. The defect reducing agent is adsorbed to the surface of polysilicon, and has an action of changing the wettability of the polysilicon surface from being hydrophobic to hydrophilic. By the action of such a defect reducing agent, re-adhesion of a residue or the like to the surface of the polished object to be polished can be prevented.

The defect reducing agent used in the present invention is not particularly limited as long as it has the above effect, and examples thereof include those containing an alcoholic hydroxy group, a carboxy group, an acyloxy group, a sulfo group, a quaternary ammonium structure, a heterocyclic structure, and a vinyl structure in the molecule. From the viewpoint of more easily obtaining the effect of the present invention, the defect reducing agent is preferably a water-soluble polymer having an alcoholic hydroxy group in a side chain.

The water-soluble polymer having an alcoholic hydroxy group in a side chain is not particularly limited, but is preferably a compound containing a structural moiety represented by a vinyl alcohol unit (—CH₂—CH(OH)—; hereinafter also referred to as “VA unit”) in the structure.

In the compound containing a VA unit in the structure, all repeating units may be substantially formed of a VA unit. The compound containing a VA unit in the structure may be a compound further containing a non-vinyl alcohol unit (a constituent unit derived from a monomer other than vinyl alcohol, hereinafter, also referred to as “non-VA unit”) in addition to the VA unit. The non-VA unit is not particularly limited, and examples thereof include constituent units derived from ethylene, vinyl acetate, vinyl propionate, vinyl hexanoate, 2-butenediol, or the like. When a polymer containing a constituent unit derived from vinyl alcohol contains a non-VA unit, the polymer may contain only one type of non-VA unit, or may contain two or more types of non-VA units. In the compound containing a VA unit in the structure, the ratio of the number of moles of the VA unit to the number of moles of all repeating units is not particularly limited, but is preferably 50% or more, more preferably 65% or more, still more preferably 70% or more, and particularly preferably 75% or more (upper limit: 100%).

The water-soluble polymer having an alcoholic hydroxy group in a side chain is preferably, for example, at least one type selected from the group consisting of polyvinyl alcohol, a polyvinyl alcohol derivative (a polyvinyl alcohol derivative having an alcoholic hydroxy group in a side chain), a copolymer of vinyl alcohol and another monomer (a copolymer of vinyl alcohol having an alcoholic hydroxy group in a side chain and another monomer), and a derivative of the copolymer (a derivative of a copolymer of vinyl alcohol having an alcoholic hydroxy group in a side chain and another monomer).

The degree of saponification of the polyvinyl alcohol is not particularly limited, but is preferably 50 mol % or more, more preferably 65 mol % or more, still more preferably 70 mol % or more, and particularly preferably 75 mol % or more (upper limit: 100 mol %).

Examples of the polyvinyl alcohol derivative include modified polyvinyl alcohol. The modified polyvinyl alcohol contains, as the non-VA unit, a structure in which a part of an alcoholic hydroxy group of a vinyl alcohol unit is substituted with another functional group (hereinafter also referred to as “modified VA unit”).

The modified polyvinyl alcohol is not particularly limited, and examples thereof include carboxy-modified polyvinyl alcohol, sulfonic acid-modified polyvinyl alcohol, phosphoric acid-modified polyvinyl alcohol, silanol-modified polyvinyl alcohol, epoxy-modified polyvinyl alcohol, acetoacetyl-modified polyvinyl alcohol, nitrile-modified polyvinyl alcohol, pyrrolidone-modified polyvinyl alcohol, silicone-modified polyvinyl alcohol, amino-modified polyvinyl alcohol, and quaternary amino-modified polyvinyl alcohol. The modified polyvinyl alcohol is not particularly limited, and examples thereof include a compound obtained by cyclic acetalization of polyvinyl alcohol (for example, polyvinyl butyral, polyvinyl propyral, polyvinyl ethylal, polyvinyl methylal, or the like).

The derivative of the copolymer of vinyl alcohol and another monomer is not particularly limited, and examples thereof include a compound further containing, in addition to the VA unit and the modified VA unit, a constituent unit such as a constituent unit derived from ethylene, a constituent unit derived from vinyl ether having a long chain alkyl group, or a constituent unit derived from a compound having at least one of an acryloyl group and a methacryloyl group.

As the water-soluble polymer having an alcoholic hydroxy group in a side chain, a polysaccharide is also preferably used. Examples of the polysaccharide include dextrin, maltodextrin, isomaltodextrin (branched maltodextrin), cyclodextrin, branched cyclodextrin, roasted dextrin, polymeric dextrin, indigestible dextrin, inulin, an inulin degradation product, agave inulin, LM pectin, HM pectin, pullulan, guar gum, a guar gum degradation product, xanthan gum, gum arabic, gum ghatti, native gellan gum, deacylated gellan gum, locust bean gum, Tara gum, galactomannan, glucomannan, konjac manan, curdlan, carrageenan, karaya gum, cassia gum, tamarind seed gum, tragacanth gum, fenugreek gum, psyllium seed gum, succinoglycan, rhamsan gum, alginic acid, sodium alginate, PGA (propylene glycol alginate ester), a soybean polysaccharide, methylcellulose, carboxymethyl cellulose, hydroxypropyl cellulose, hydroxypropyl methyl cellulose, agar, fucoidan, porphyran, laminaran, starch, resistant starch, isomaltulose, polydextrose, indigestible glucan, and arabinogalactan.

Among them, the defect reducing agent is more preferably at least one type selected from the group consisting of polyvinyl alcohol, sulfonic acid-modified polyvinyl alcohol, and a vinyl alcohol-butenediol copolymer, and still more preferably a vinyl alcohol-butenediol copolymer.

The weight average molecular weight of the defect reducing agent is not particularly limited, but is preferably 1,000 or more, more preferably 3,000 or more, and still more preferably 5,000 or more. The weight average molecular weight of the defect reducing agent is not particularly limited, but is preferably 1,000,000 or less, more preferably 100,000 or less, and still more preferably 50,000 or less. That is, the weight average molecular weight of the defect reducing agent is preferably 1,000 or more and 1,000,000 or less, more preferably 3,000 or more and 100,000 or less, and still more preferably 5,000 or more and 50,000 or less.

As the defect reducing agent, one type may be used alone or two or more types may be used in combination. As the defect reducing agent, a commercially available product may be used, or a synthetic product may be used.

The lower limit of the concentration (content) of the defect reducing agent in the polishing composition is preferably 0.005 mass % (50 mass ppm) or more, more preferably 0.01 mass % (100 mass ppm) or more, still more preferably 0.015 mass % (150 mass ppm) or more, and particularly preferably 0.02 mass % (200 mass ppm) or more from the viewpoint of further enhancing the hydrophilicity of the object to be polished. The upper limit of the concentration (content) of the defect reducing agent in the polishing composition is preferably 1 mass % (10,000 mass ppm) or less, more preferably 0.8 mass % (8,000 mass ppm) or less, still more preferably 0.5 mass % (5,000 mass ppm) or less, even more preferably 0.3 mass % (3,000 mass ppm) or less, and particularly preferably 0.1 mass % (1,000 mass ppm) or less. That is, the concentration (content) of the defect reducing agent in the polishing composition is preferably 0.005 mass % (50 mass ppm) or more and 1 mass % (10,000 mass ppm) or less, more preferably 0.01 mass % (100 mass ppm) or more and 0.8 mass % (8,000 mass ppm) or less, still more preferably 0.015 mass % (150 mass ppm) or more and 0.5 mass % (5,000 mass ppm) or less, even more preferably 0.02 mass % (200 mass ppm) or more and 0.3 mass % (3,000 mass ppm) or less, and particularly preferably 0.02 mass % (200 mass ppm) or more and 0.1 mass % (1,000 mass ppm) or less. When the polishing composition contains two or more types of defect reducing agents, the concentration (content) of the defect reducing agent means the total thereof.

### [Inorganic Salt]

The polishing composition according to the present invention preferably contains an inorganic salt. The inorganic salt enhances the electrical conductivity of the polishing composition and compresses the electric double layer of the surface of the object to be polished (for example, silicon oxide) containing a material other than polysilicon. Therefore, the action of the abrasive grains is improved, and the polishing removal rate of the material other than polysilicon can be improved. The inorganic salt may act as a polishing removal rate improver for the material other than polysilicon.

Examples of the inorganic salt include sodium nitrate, potassium nitrate, ammonium nitrate, magnesium nitrate, calcium nitrate, sodium nitrite, potassium nitrite, lithium carbonate, sodium carbonate, potassium carbonate, magnesium carbonate, calcium carbonate, lithium hydrogen carbonate, sodium hydrogen carbonate, potassium hydrogen carbonate, ammonium carbonate, sodium bicarbonate, sodium sulfate, potassium sulfate, ammonium sulfate, calcium sulfate, magnesium sulfate, sodium sulfite, potassium sulfite, calcium sulfite, magnesium sulfite, potassium thiosulfate, lithium sulfate, magnesium sulfate, sodium thiosulfate, sodium hydrogen sulfite, sodium hydrogen sulfate, potassium hydrogen sulfate, lithium fluoride, sodium fluoride, potassium fluoride, calcium fluoride, ammonium fluoride, potassium chloride, sodium chloride, ammonium chloride, calcium chloride, potassium bromide, sodium bromide, ammonium bromide, calcium bromide, sodium iodide, potassium iodide, potassium triiodide, calcium iodide, trilithium phosphate, tripotassium phosphate, trisodium phosphate, triammonium phosphate, sodium monohydrogen phosphate, potassium monohydrogen phosphate, sodium dihydrogen phosphate, potassium dihydrogen phosphate, and ammonium dihydrogen phosphate. One type of these inorganic salts may be used alone or two or more types thereof may be used in combination. As the inorganic salt, a commercially available product may be used, or a synthetic product may be used.

Among these inorganic salts, ammonium sulfate, ammonium nitrate, ammonium carbonate, triammonium phosphate, and diammonium phosphate are preferable in that a metal or a halogen is not contained. Use of an inorganic salt containing no metal or halogen leads to advantages such as reduction of metal residues, improvement of handling safety, and prevention of corrosion of the object to be polished.

The concentration (content) of the inorganic salt in the polishing composition is not particularly limited. In the case of a polishing composition used for polishing the object to be polished as a polishing liquid as it is, the lower limit of the concentration (content) of the inorganic salt in the polishing composition is preferably 0.2 mass % or more, more preferably 0.3 mass % or more, still more preferably 0.4 mass % or more, and particularly preferably 0.5 mass % or more with respect to the total mass of the polishing composition. The upper limit of the concentration (content) of the inorganic salt in the polishing composition is preferably 3.0 mass % or less, more preferably 2.5 mass % or less, still more preferably 2.0 mass % or less, and particularly preferably 1.5 mass % or less with respect to the total mass of the polishing composition.

That is, the concentration (content) of the inorganic salt is preferably 0.2 mass % or more and 3.0 mass % or less, more preferably 0.3 mass % or more and 2.5 mass % or less, still more preferably 0.4 mass % or more and 2.0 mass % or less, and particularly preferably 0.5 mass % or more and 1.5 mass % or less with respect to the total mass of the polishing composition. When the polishing composition contains two or more types of inorganic salts, the concentration (content) of the inorganic salt means the total thereof.

### [Dispersing Medium]

The polishing composition according to the present invention preferably further contains a dispersing medium. Examples of the dispersing medium include water; alcohols such as methanol, ethanol, and ethylene glycol; ketones such as acetone, and mixtures thereof. Among them, water is preferable as the dispersing medium. That is, according to a more preferred embodiment of the present invention, the dispersing medium contains water. According to a further preferred embodiment of the present invention, the dispersing medium is substantially formed of water. The term “substantially” as described above is intended to mean that a dispersing medium other than water can be contained as long as the objective effect of the present invention can be achieved, and more specifically, the dispersing medium is preferably formed of 90 mass % or more and 100 mass % or less of water and 0 mass % or more and 10 mass % or less of a dispersing medium other than water, and more preferably formed of 99 mass % or more and 100 mass % or less of water and 0 mass % or more and 1 mass % or less of a dispersing medium other than water. Most preferably, the dispersing medium is water.

From the viewpoint of preventing the action of the components contained in the polishing composition from being inhibited, water that contains as few impurities as possible is preferable as the dispersing medium, and specifically, pure water, ultrapure water, or distilled water from which impurity ions are removed with an ion exchange resin and then foreign substances are removed through a filter is more preferable.

### [pH and pH Adjusting Agent]

The pH of the polishing composition according to the present invention is preferably 1.0 or more, more preferably 1.5 or more, and still more preferably 2.0 or more. The pH is preferably 7.0 or less, more preferably less than 5.0, still more preferably 4.5 or less, and particularly preferably 4.0 or less from the viewpoint of improving the polishing removal rate of the surface of the object to be polished (for example, silicon oxide) containing a material other than polysilicon. That is, the pH of the polishing composition according to the present invention is preferably 1.0 or more and 7.0 or less, more preferably 1.0 or more and less than 5.0, and still more preferably 1.5 or more and 4.5 or less.

The polishing composition according to the present invention may contain a pH adjusting agent for adjusting pH. The pH adjusting agent may be either an acid or a base, or may be either an inorganic compound or an organic compound. As the pH adjusting agent, one type can be used alone or two or more of types can be used in admixture.

Specific examples of the acid that can be used as the pH adjusting agent include inorganic acids such as hydrochloric acid, sulfuric acid, nitric acid, hydrofluoric acid, boric acid, carbonic acid, hypophosphorous acid, phosphorous acid, and phosphoric acid; and organic acids such as formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexanoic acid, n-octanoic acid, 2-ethylhexanoic acid, benzoic acid, glycolic acid, salicylic acid, glyceric acid, oxalic acid, malonic acid, succinic acid, glutaric acid, adipic acid, pimelic acid, maleic acid, phthalic acid, malic acid, tartaric acid, citric acid, lactic acid, diglycolic acid, 2-furancarboxylic acid, 2,5-furandicarboxylic acid, 3-furancarboxylic acid, 2-tetrahydrofurancarboxylic acid, methoxyacetic acid, methoxyphenylacetic acid, and phenoxyacetic acid.

Examples of the base that can be used as the pH adjusting agent include amines such as an aliphatic amine and an aromatic amine, organic bases such as quaternary ammonium hydroxide, hydroxides of alkali metals such as sodium hydroxide and potassium hydroxide, hydroxides of group 2 elements, and ammonia.

The addition amount of the pH adjusting agent is not particularly limited, and may be appropriately adjusted so that the polishing composition has a desired pH. The pH of the polishing composition can be measured by, for example, a pH meter, and specifically, can be measured by the method described in examples.

### Electrical Conductivity of Polishing Composition

The electrical conductivity (EC) of the polishing composition according to the present invention is not particularly limited, but is preferably 1 mS/cm or more, and more preferably 3 mS/cm or more. The electrical conductivity (EC) of the polishing composition according to the present invention is preferably 20 mS/cm or less, and more preferably 15 mS/cm or less. That is, the electrical conductivity (EC) of the polishing composition according to the present invention is preferably 1 mS/cm or more and 20 mS/cm or less, and more preferably 3 mS/cm or more and 15 mS/cm or less. When the electrical conductivity (EC) of the polishing composition is in such a range, the polishing removal rate of a material (for example, silicon oxide) other than polysilicon can be improved. In addition, repulsion between abrasive grains can be appropriately adjusted, and stability can be ensured. The electrical conductivity of the polishing composition can be adjusted by, for example, the type and amount of the inorganic salt, the pH adjusting agent, or the like. The electrical conductivity (EC) of the polishing composition can be measured by the method described in examples.

### [Other Components]

If necessary, the polishing composition of the present invention may further contain other components such as a complexing agent, a metal anticorrosive, an antiseptic agent, an antifungal agent, an oxidizing agent, a reducing agent, and a surfactant. Hereinafter, an antiseptic agent and an antifungal agent which are preferred components will be described.

### (Antiseptic Agent and Antifungal Agent)

Examples of the antiseptic agent and the antifungal agent that can be added to the polishing composition according to the present invention include isothiazoline-based antiseptic agents such as 2-methyl-4-isothiazoline-3-one and 5-chloro-2-methyl-4-isothiazoline-3-one, a paraoxybenzoic acid ester, and phenoxyethanol. These antiseptic agents and antifungal agents may be used alone or two or more of types thereof may be used in admixture.

### [Form of Polishing Composition]

The polishing composition according to the present invention is typically supplied in the form of a polishing liquid containing the polishing composition to an object to be polished, and is used for polishing the object to be polished. For example, the polishing composition according to the present invention may be diluted (typically diluted with water) and used as a polishing liquid, or may be used as a polishing liquid as it is. That is, the concept of the polishing composition according to the present invention includes both a polishing composition (working slurry) supplied to an object to be polished and used for polishing the object to be polished and a concentrated liquid (a stock solution of a working slurry) used for polishing after dilution. The concentration factor of the concentrated liquid can be set to, for example, about 2 times or more and 100 times or less on a volume basis, and usually about 3 times or more and 50 times or less is appropriate.

### [Object to be Polished]

The object to be polished according to the present invention is not particularly limited, and examples thereof include single crystal silicon, polycrystalline silicon (polysilicon), polycrystalline silicon doped with an n-type or p-type impurity, amorphous silicon, amorphous silicon doped with an n-type or p-type impurity, silicon oxide, silicon nitride, silicon carbonitride (SiCN), a metal, SiGe, and a carbon-containing material. According to an embodiment of the present invention, the object to be polished contains silicon oxide other than polysilicon.

Examples of the object to be polished containing silicon oxide include a TEOS type silicon oxide film (hereinafter, also simply referred to as “TEOS” or “TEOS film”) produced using tetraethyl orthosilicate as a precursor, an HDP (High Density Plasma) film, a USG (Undoped Silicate Glass) film, a PSG (Phosphorus Silicate Glass) film, a BPSG (Boron-Phospho Silicate Glass) film, and an RTO (Rapid Thermal Oxidation) film.

Examples of the metal include tungsten, copper, aluminum, cobalt, hafnium, nickel, gold, silver, platinum, palladium, rhodium, ruthenium, iridium, and osmium.

Examples of the carbon-containing material include amorphous carbon, spin-on carbon (SOC), diamond-like carbon (DLC), nanocrystalline diamond, graphene, SiOC (carbon-containing silicon oxide obtained by doping SiO₂ with C) which is a low dielectric constant (Low-k) material, and silicon carbide. A film containing the carbon-containing material can be formed by CVD, PVD, a spin coating method, or the like.

The object to be polished may be a commercially available product or may be produced by a known method.

Among them, an object to be polished containing polysilicon is preferable. Therefore, according to a preferred embodiment of the present invention, the polishing composition is used for polishing an object to be polished containing polysilicon.

### [Method for Producing Polishing Composition]

A method for producing the polishing composition according to the present embodiment is not particularly limited, and the polishing composition can be obtained, for example, by stirring and mixing abrasive grains, a polishing removal rate inhibitor, a dispersing medium, a defect reducing agent, and other additives added as necessary. The details of each component are as described above.

The temperature at the time of mixing the respective components is not particularly limited, but is preferably 10° C. or higher and 40° C. or lower, and heating may be performed in order to increase the rate of dissolution. The mixing time is also not particularly limited as long as uniform mixing can be achieved.

### [Polishing Method and Method for Producing Semiconductor Substrate]

As described above, the polishing composition according to the present invention is particularly suitably used for polishing the object to be polished containing polysilicon. Therefore, the present invention provides a polishing method for polishing the object to be polished containing polysilicon with the polishing composition according to the present embodiment. The present invention also provides a method for producing a semiconductor substrate, the method including a step of polishing a semiconductor substrate containing polysilicon by the polishing method.

As a polishing apparatus, it is possible to use a general polishing apparatus, to which a holder for holding a substrate or the like having an object to be polished and a motor or the like capable of changing the rotational speed are attached, and which has a polishing table to which a polishing pad (polishing cloth) can be attached.

As the polishing pad, a general nonwoven fabric, polyurethane, a porous fluororesin, or the like can be used without particular limitation. The polishing pad is preferably grooved such that a polishing liquid is accumulated.

As for the polishing conditions, for example, the rotational speeds of the polishing table (platen) and the carrier (head) are each independently preferably 10 rpm (0.17 s⁻¹) or more and 500 rpm (8.33 s⁻¹) or less. The pressure (polishing pressure) applied to the substrate having the object to be polished is preferably 0.5 psi (3.45 kPa) or more and 10 psi (68.9 kPa) or less.

A method of supplying the polishing composition to the polishing pad is not particularly limited, and for example, a method of continuously supplying the polishing composition with a pump or the like is adopted. This supply amount is not limited, but it is preferable that the surface of the polishing pad is always covered with the polishing composition according to the present invention.

The polishing composition according to the present embodiment may be of a one-pack type or a multi-pack type including a two-pack type. The polishing composition according to the present invention may be prepared by diluting a stock solution of the polishing composition, for example, three times or more using a diluent such as water.

### [Polishing Removal Rate]

As described above, the polishing composition according to the present invention can reduce the polishing removal rate of polysilicon. Specifically, the polishing removal rate of polysilicon is preferably 45 Å/min or less, more preferably 35 Å/min or less, still more preferably 32 Å/min or less, and even more preferably 30 Å/min or less.

### [Selection Ratio]

According to an embodiment of the present invention, the polishing composition has a characteristic that a polishing removal rate (Å/min) of silicon oxide with respect to a polishing removal rate (Å/min) of polysilicon is 2 or more, 3 or more, 4 or more, 5 or more, 6 or more, or 7 or more. According to an embodiment of the present invention, the polishing composition has a characteristic that a polishing removal rate (Å/min) of silicon oxide with respect to a polishing removal rate (Å/min) of polysilicon is 20 or less, 15 or less, 10 or less, or 9 or less.

### [Number of Defects (Total)]

As described above, the polishing composition according to the present invention can reduce the number of defects on the surface of polysilicon after polishing is completed. Specifically, the number (total) of defects of 0.08 μm or more is more preferably 5,000 or less, still more preferably 3,000 or less (lower limit: 0). The number of defects is a value measured by the method described in examples.

Although the embodiments of the present invention have been described in detail, this is illustrative and exemplary and not restrictive, and it is clear that the scope of the present invention should be interpreted by the appended claims.

The present invention includes the following aspects and forms.

1. A polishing composition containing abrasive grains, and a polishing removal rate inhibitor that reduces a polishing removal rate of polysilicon, in which the polishing removal rate inhibitor is a water-soluble polymer meeting all requirements below: 1) a number average molecular weight is 200 or more and 600 or less; 2) a compound having a repeating unit formed of AO in which A is an alkylene group and O is an oxygen atom is contained; and 3) a compound having a special repeating unit in which two oxygen atoms are further added to the repeating unit is contained in an amount of more than 0 mass % and less than 0.1 mass % with respect to the entire water-soluble polymer.

2. A polishing composition according to 1, in which a number of carbon atoms in the alkylene group is 3.

3. A polishing composition according to 1 or 2, in which the polishing removal rate inhibitor contains polypropylene glycol.

4. A polishing composition according to any one of 1 to 3, further containing a water-soluble polymer having an alcoholic hydroxy group in a side chain.

5. A polishing composition according to any one of 1 to 4, in which the abrasive grains contain anion-modified colloidal silica.

6. A polishing composition according to any one of 1 to 5, in which a pH is 1.0 or more and less than 5.0.

7. A polishing composition according to any one of 1 to 6, containing a polishing removal rate improver for a material other than the polysilicon.

8. A polishing composition according to 7, in which the polishing removal rate improver is an inorganic salt.

9. A polishing composition according to any one of 1 to 8, in which a material other than the polysilicon is silicon oxide.

10. A polishing composition according to any one of 1 to 9, in which a polishing removal rate (Å/min) of silicon oxide with respect to a polishing removal rate (Å/min) of polysilicon is 5 or more.

### EXAMPLES

The present invention will be described in more detail with reference to the following examples and comparative examples. However, the technical scope of the present invention is not limited only to the following examples. Unless otherwise specified, “%” and “part(s)” mean “mass %” and “part(s) by mass”, respectively. In the following examples, unless otherwise specified, operations were performed under the conditions of room temperature (20° C. or higher and 25° C. or lower)/relative humidity of 40% RH or higher and 50% RH or lower. Each physical property was measured as follows.

### <Average Primary Particle Size of Abrasive Grains>

The average primary particle size of the abrasive grains was calculated from the specific surface area of the abrasive grains measured by the BET method using “Flow Sorb II 2300” manufactured by Micromeritics Instruments Corporation and the true density of the abrasive grains.

### <Average Secondary Particle Size of Abrasive Grains>

The average secondary particle size of the abrasive grains was measured as the volume average particle size (volume-based arithmetic average size: Mv) using a dynamic light scattering particle size/particle size distribution analyzer UPA-UT151 (manufactured by Nikkiso Co., Ltd.).

### <Zeta Potential of Abrasive Grains>

The zeta potential of abrasive grains was measured using a zeta potential measurement apparatus (trade name “ELS-Z”) manufactured by Otsuka Electronics Co., Ltd.

### <pH of Polishing Composition>

The pH of the polishing composition was measured using a glass electrode type hydrogen ion concentration indicator (manufactured by Horiba, Ltd., model number: F-23) by performing three-point calibration using standard buffer solution (phthalate pH buffer solution, pH: 4.01 (25° C.), neutral phosphate pH buffer solution, pH: 6.86 (25° C.), carbonate pH buffer solution, pH: 10.01 (25° C.)), then placing a glass electrode in the polishing composition, and measuring a value after 2 minutes or more have passed for stabilization.

### <Number Average Molecular Weight, Weight Average Molecular Weight>

As the number average molecular weight and the weight average molecular weight, values of the number average molecular weight and the weight average molecular weight (in terms of polyethylene glycol) measured by gel permeation chromatography (GPC) were used. The number average molecular weight and the weight average molecular weight were measured with the following apparatus and conditions:
GPC apparatus: manufactured by Shimadzu Corporation
Model: Prominence+ELSD detector (ELSD-LTII)
Column: VP-ODS (manufactured by Shimadzu Corporation)
Mobile phase A: MeOH
   B: 1% acetic acid aqueous solution
Flow rate: 1 mL/min
Detector: ELSD temp. 40° C., Gain 8, N₂ GAS 350 kPa
Oven temperature: 40° C.
Injection amount: 40 μL

### <Electrical Conductivity of Polishing Composition>

The electrical conductivity (EC) of the polishing composition was measured with a tabletop electrical conductivity meter (manufactured by HORIBA, Ltd., model number: DS-71 LAQUA (registered trademark)).

### <Sulfonic Acid-Immobilized Colloidal Silica>

Sulfonic acid-immobilized colloidal silica contained in the polishing composition was prepared by the method described in “Sulfonic acid-functionalized silica through quantitative oxidation of thiol groups”, Chem. Commun. 246-247 (2003) using colloidal silica having an average secondary particle size of 68.9 nm.

### <Polypropylene Glycol>

### (Preparation of PPG-C6)

Commercially available polypropylene glycol (NEWPOL PP-400 manufactured by Sanyo Chemical Industries, Ltd.: content of PPG+O₂: 0.210 mass %) was prepared (PPG-C6). The content of PPG+O₂ was analyzed using a liquid chromatography mass spectrometer (LC/MS). The number average molecular weight of PPG-C6 is shown in Table 1.
LC/MS apparatus (LC): manufactured by Shimadzu Corporation
Model: Prominence UFLC
Column: Cadenza CD-C18 (manufactured by Imtakt Corporation)
Mobile phase A: 0.1% formic acid aqueous solution
   B: Acetonitrile
A:B=100:0 (0 min)→A:B=0:100 (5 min)
→A:B=80:20 (5.01 min)→A:B=80:20 (10 min)
→A:B=70:30 (10.01 min)→A:B=70:30 (30 min)
→A:B=55:45 (30.01 min)→A:B=55:45 (40 min)
→A:B=45:55 (40.01 min)→A:B=45:55 (50 min)
Flow rate: 0.4 mL/min
Column temperature: 40° C.
Injection amount: 5 μL
LC/MS apparatus (MS): manufactured by AB SCIEX Corporation
Model: Triple TOF 5600+
Ionization method: ESI IonSpray Voltage Floating: 5.5
kV (Positive mode)
Mass range: m/z 50 to 1500

### (Preparation of PPG-C1)

AMBERLITE (registered trademark) FPX66 which is a synthetic adsorbent manufactured by Organo Corporation was cleaned with an alcohol and then further cleaned with pure water, then mixed with a 12 mass % aqueous solution of PPG-C1, followed by stirring for 2 hours, and then, the synthetic adsorbent was separated by filtration with a nylon mesh having an opening of 100 μm to prepare PPG-C1 (content of PPG+O₂: 0%).

### (Preparation of PPG-1 to PPG-5 and PPG-C2 to PPG-C5)

PPG-1 to PPG-5 and PPG-C2 to PPG-C5 were prepared by appropriately mixing PPG-C6 and PPG-C1 so that the content of PPG+02 was as shown in Table 1. The number average molecular weights of PPG-1 to PPG-5 and PPG-C2 to PPG-C5 are shown in Table 1.

### Example 1

### <Preparation of Polishing Composition>

To water as a dispersing medium, the sulfonic acid-immobilized colloidal silica (average primary particle size: 34.9 nm, average secondary particle size: 68.9 nm) prepared above was added to a final concentration of 2.3 mass %, PPG-1 was added to a final concentration of 0.6 mass %, a butenediol-vinyl alcohol copolymer (degree of polymerization: 300, manufactured by Mitsubishi Chemical Corporation, product name: Nichigo G-Polymer AZF8035W) was added to a final concentration of 750 mass ppm, and ammonium sulfate (manufactured by Tomiyama Pure Chemical Industries, Ltd.) was added to a final concentration of 0.5 mass %, followed by stirring and mixing (stirring temperature: 25° C., stirring time: 20 minutes). The pH of the polishing composition was adjusted to pH 2.1 using nitric acid to complete polishing composition 1. The zeta potential of the sulfonic acid-immobilized colloidal silica in the polishing composition was −55 mV, and the electrical conductivity (EC) of the polishing composition was 12.0 mS/cm.

### Examples 2 to 5, Comparative Examples 1 to 6

Polishing compositions were prepared in the same manner as in Example 1 except that PPG-1 was changed to PPG-2 to PPG-5 and PPG-C1 to PPG-C6, respectively.

### Comparative Example 7

A polishing composition was prepared in the same manner as in Example 1 except that PPG-1 was not added.

### Example 6

A polishing composition was prepared in the same manner as in Example 5 except that the pH of the polishing composition was changed to pH 5.5 by changing the amount of nitric acid.

### Example 7

A polishing composition was prepared in the same manner as in Example 5 except that the butenediol-vinyl alcohol copolymer (degree of polymerization: 300, manufactured by Mitsubishi Chemical Corporation, product name: Nichigo G-Polymer AZF8035W) was changed to polyvinyl alcohol (manufactured by JAPAN VAM & POVAL CO., LTD., product name: JMR-10HH, average molecular weight: 9000, degree of polymerization: 300).

### [Evaluation]

As the object to be polished, one obtained by forming a polysilicon film having a thickness of 5,000 A on the surface of a silicon wafer (300 mm, blanket wafer) was prepared.

As the object to be polished, one obtained by forming a silicon oxide film (derived from TEOS) having a thickness of 10,000 A on the surface of a silicon wafer (300 mm, blanket wafer) was prepared.

The object to be polished was polished under the following conditions using the polishing compositions obtained in the above examples and comparative examples:

### <Polishing Conditions>

Polishing machine: 300 mm polishing machine (Ebara Corporation, model number: F-REX300E)
Polishing pad: pad made of polyurethane (IC1000 manufactured by Nitta DuPont Co., Ltd.)
Pressure: 2.0 psi (13.79 kPa)
Polishing table (platen) rotational speed: 31 rpm
Carrier (head) rotational speed: 30 rpm
Supply of polishing composition: free-flowing
Flow rate of polishing composition: 200 ml/min
Polishing time: 60 seconds

### <Polishing Removal Rate>

The polishing removal rate (polishing removal rate) of the object to be polished was calculated according to the following formula.

$$Polishing removal rate [ Å / min ] = ( film pressure [ Å ] before polishing - film pressure [ Å ] after polishing ) / polishing time [ min ] \qquad [ Math . 1 ]$$

The film thickness of the object to be polished before and after polishing was obtained by a light interference type film thickness measurement apparatus (manufactured by KLA-Tencor Corporation, model number: ASET-F5X), and the polishing removal rate was calculated by dividing the difference by the polishing time.

### (Cleaning Apparatus and Cleaning Conditions)

After the object to be polished was polished under the above polishing conditions, the polished object to be polished was removed from the polishing table (platen). Subsequently, in the same polishing apparatus, the polished object to be polished was cleaned by a cleaning method of rubbing the polished object to be polished under the following conditions while pressure was applied with a polyvinyl alcohol (PVA) sponge which is a cleaning brush using the following cleaning liquid:
apparatus: 300 mm polishing machine (Ebara Corporation, model number: F-REX300E)
cleaning liquid: 0.3 mass % ammonia water
cleaning brush rotational speed: 100 rpm
object to be cleaned (polished object to be polished) rotational speed: 100 rpm
flow rate of cleaning liquid: 1,000 mL/min
cleaning time: 20 seconds.

With respect to the surface of the object to be polished (polysilicon) obtained by the above cleaning, the number of defects (the number of organic residues) of 0.08 μm or more was evaluated according to the following method. Specifically, defects of 0.08 μm or more on the entire surface of the object to be polished (excluding the outer circumference of 5 mm) were detected using a defect detection apparatus (wafer inspection apparatus) “Surfscan SP5” manufactured by KLA-Tencor Corporation. The detected defects were measured with a review SEM (RS-6000, manufactured by Hitachi High-Technologies Corporation). Specifically, first, 100 foreign substances present in the remaining portion excluding a portion having a width of 5 mm from the outer peripheral end portion of one surface of each substrate were sampled by SEM observation. Subsequently, the organic residues and the abrasive grain residues were visually discriminated from the sampled 100 foreign substances by SEM observation, and the number thereof was checked to calculate the proportion (%) of the organic residues and the proportion (%) of the abrasive grain residues in the foreign substances. Then, the product of the number of foreign substances (number) of 0.08 μm or more detected with the defect detection apparatus described above and the proportion (%) of organic residues in the foreign substances calculated from the SEM observation result was defined as the number of organic residues (number), and the product of the number of foreign substances (number) of 0.08 μm or more detected with the defect detection apparatus described above and the proportion (%) of abrasive grain residues was calculated as the number of abrasive grain residues.

Further, the number of organic residues (number) and the number of abrasive grain residues (number) were subtracted from the number of foreign substances (number) of 0.08 μm or more to obtain other defects (Other) (number).

The configurations and evaluation results of the polishing compositions of examples and comparative examples are shown in the following Table 1.

TABLE 1

| | | Number | Content | | | | Polishing |
|---|---|---|---|---|---|---|---|
| | | average | of PPG + | | | | removal rate |
| | | molecular | O₂ | Additive | Additive | | Polysilicon |
| | PPG | weight | [mass %] | 1 | 2 | pH | [Å/min] |
| Example | PPG-1 | 457.7 | 0.001 | Ammonium | Butenediol- | 2.1 | 28.6 |
| 1 | | | | sulfate | vinyl | | |
| Example | PPG-2 | 465.7 | 0.009 | | alcohol | 2.1 | 30.1 |
| 2 | | | | | copolymer | | |
| Example | PPG-3 | 459.9 | 0.002 | | (degree of | 2.1 | 34.1 |
| 3 | | | | | polymerization: | | |
| Example | PPG-4 | 460.9 | 0.032 | | 300) | 2.1 | 24.2 |
| 4 | | | | | | | |
| Example | PPG-5 | 460.7 | 0.042 | | | 2.1 | 25.0 |
| 5 | | | | | | | |
| Comparative | PPG- | 455.5 | 0.000 | | | 2.1 | 31.5 |
| Example 1 | C1 | | | | | | |
| Comparative | PPG- | 458.7 | 0.176 | | | 2.1 | 28.2 |
| Example 2 | C2 | | | | | | |
| Comparative | PPG- | 460.2 | 0.116 | | | 2.1 | 27.3 |
| Example 3 | C3 | | | | | | |
| Comparative | PPG- | 459.3 | 0.108 | | | 2.1 | 25.1 |
| Example 4 | C4 | | | | | | |
| Comparative | PPG- | 458.9 | 0.166 | | | 2.1 | 25.4 |
| Example 5 | C5 | | | | | | |
| Comparative | PPG- | 461.0 | 0.210 | | | 2.1 | 28.6 |
| Example 6 | C6 | | | | | | |
| Comparative | — | — | — | | | 2.1 | 198.0 |
| Example 7 | | | | | | | |
| Example | PPG-5 | 460.7 | 0.042 | | | 5.5 | 42.0 |
| 6 | | | | | | | |
| Example | PPG-5 | 460.7 | 0.042 | | PVA | 2.1 | 32.0 |
| 7 | | | | | (degree of | | |
| | | | | | polymerization: | | |
| | | | | | 300) | | |

| | Polishing | | Poly-Si defect | | | |
|---|---|---|---|---|---|---|
| | removal rate | | | Abrasive | | |
| | Silicon | | Organic | grain | | |
| | oxide | Selection | residues | residues | Other | Total |
| | [Å/min] | ratio | [number] | [number] | [number] | [number] |
| Example | 173 | 6.0 | 3250 | 86 | 163 | 3499 |
| 1 | | | | | | |
| Example | 175 | 5.8 | 611 | 189 | 86 | 886 |
| 2 | | | | | | |
| Example | 172 | 5.0 | 315 | 1212 | 15 | 1542 |
| 3 | | | | | | |
| Example | 171 | 7.1 | 710 | 112 | 38 | 860 |
| 4 | | | | | | |
| Example | 176 | 7.0 | 680 | 83 | 23 | 786 |
| 5 | | | | | | |
| Comparative | 173 | 5.5 | 3 | 1983 | 3456 | 5442 |
| Example 1 | | | | | | |
| Comparative | 173 | 6.1 | 21405 | 2983 | 440 | 24828 |
| Example 2 | | | | | | |
| Comparative | 176 | 6.5 | 8905 | 3800 | 3734 | 16439 |
| Example 3 | | | | | | |
| Comparative | 174 | 6.9 | 21405 | 3000 | 427 | 24832 |
| Example 4 | | | | | | |
| Comparative | 173 | 6.8 | 11153 | 6453 | 301 | 17907 |
| Example 5 | | | | | | |
| Comparative | 175 | 6.1 | 84652 | 998 | 7534 | 93184 |
| Example 6 | | | | | | |
| Comparative | 233 | 1.2 | 4 | 205 | 711 | 920 |
| Example 7 | | | | | | |
| Example | 120 | 2.9 | 1719 | 620 | 29 | 2368 |
| 6 | | | | | | |
| Example | 210 | 6.6 | 2707 | 976 | 46 | 3729 |
| 7 | | | | | | |

What is claimed is:

1. A polishing composition, comprising:
abrasive grains; and
a polishing removal rate inhibitor that reduces a polishing removal rate of polysilicon, wherein
the polishing removal rate inhibitor is a water-soluble polymer meeting all requirements below:
1) a number average molecular weight is 200 or more and 600 or less;
2) a compound having a repeating unit formed of AO in which A is an alkylene group and O is an oxygen atom is contained; and
3) a compound having a special repeating unit in which two oxygen atoms are further added to the repeating unit is contained in an amount of more than 0 mass % and less than 0.1 mass % with respect to the entire water-soluble polymer.

2. A polishing composition according to claim 1, wherein a number of carbon atoms in the alkylene group is 3.

3. A polishing composition according to claim 1, wherein the polishing removal rate inhibitor contains polypropylene glycol.

4. A polishing composition according to claim 1, further comprising a water-soluble polymer having an alcoholic hydroxy group in a side chain.

5. A polishing composition according to claim 1, wherein the abrasive grains contain anion-modified colloidal silica.

6. A polishing composition according to claim 1, wherein a pH is 1.0 or more and less than 5.0.

7. A polishing composition according to claim 1, comprising a polishing removal rate improver for a material other than the polysilicon.

8. A polishing composition according to claim 7, wherein the polishing removal rate improver is an inorganic salt.

9. A polishing composition according to claim 7, wherein the material other than the polysilicon is silicon oxide.

10. A polishing composition according to claim 1, wherein a polishing removal rate (Å/min) of silicon oxide with respect to a polishing removal rate (Å/min) of polysilicon is 5 or more.
